(19) United States
(12) Patent Application Publication
(10) Pub. No.: US 2026/0307823 A1
(43) Pub. Date: Oct. 8, 2026

(54) System and Method for Controlling Satellites in Orbit

(71) Applicant: Carnegie Mellon University, Pittsburgh, PA (US)

(72) Inventor: Zachary Manchester, Pittsburgh, PA (US)

(21) Appl. No.: 19/481,906

(22) PCT Filed: May 10, 2024
(86) PCT No.: PCT/US24/28763

§ 371 Date: Nov. 6, 2025

Related U.S. Application Data
(60) Provisional application No. 63/465,746, filed on May 11, 2023.

(51) Int. Cl. B64G 1/24; B64G 1/10

(52) U.S. Cl. CPC B64G 1/2421; B64G 1/1085; B64G 1/244

(57) ABSTRACT

Provided are systems and methods for controlling a plurality of satellites. A system includes at least one computing device configured to determine a control plan based on a target separation in along-track and cross-track directions for a plurality of satellites including at least a first satellite and a second satellite, the control plan including at least one drag modulation parameter for each satellite, control the first satellite to lower an orbital altitude of the first satellite based on the at least one drag modulation parameter, such that a mean motion and nodal precession rate of the first satellite increases, based on the control plan and after lowering the orbital altitude of the first satellite, and control the second satellite to lower an orbital altitude of the second satellite based on the at least one drag modulation parameter to achieve the target separation.

### CROSS REFERENCE TO RELATED APPLICATIONS

This application is the United States national phase of International Application No. PCT/US24/28763, filed on May 10, 2024, and claims the benefit of U.S. Provisional Patent Application No. 63/465,746, filed on May 11, 2023, the disclosures of which are hereby incorporated by reference in their entireties.

### GOVERNMENT LICENSE RIGHTS

This invention was made with United States government support under 2111751 awarded by the National Science Foundation and award number 80NSSC21K0446 awarded by the National Aeronautics Space Administration. The United States government has certain rights in the invention.

### BACKGROUND OF THE INVENTION

### 1. Field

This disclosure relates generally to satellites and, in non-limiting embodiments, to a systems, methods, and devices for controlling satellites in orbit.

### 2. Technical Considerations

Formations of multiple satellites are frequently used to perform tasks that a single satellite cannot accomplish alone. Examples include satellite navigation systems, like the global positioning system (GPS), and communications constellations like Iridium® and Starlink™. The ability to maneuver and control the relative positions of such satellites is key to establishing and maintaining a formation. Typically, such maneuvering requires a propulsion system and the consumption of propellant, the supply of which can be very limited, especially on smaller spacecraft. In fact, many small spacecraft are not equipped with a propulsion system at all.

Approaches that do not rely on propulsion systems and instead use differential-drag formation flying methods ignore the cross-track influence of nodal precession because it is small compared to the along-track drift, requiring large altitude differences and long time horizons to have a significant effect. Most of these approaches fail to consider large out-of-plane or cross-track motion of satellites. The approaches that do use nodal precession lack control methods for synchronizing the along-track and cross-track separation state of the satellites, and therefore are not desirable for controlling a plurality of satellites into a target formation.

### SUMMARY

According to non-limiting embodiments or aspects, provided is a system for controlling a plurality of satellites in orbit, comprising: at least one computing device including at least one processor, the at least one computing device configured to: determine a control plan based on a target separation in along-track and cross-track directions for a plurality of satellites comprising at least a first satellite and a second satellite, the control plan comprising at least one drag modulation parameter for each satellite; control the first satellite to lower an orbital altitude of the first satellite based on the at least one drag modulation parameter, such that a mean motion and nodal precession rate of the first satellite increases; and based on the control plan and after lowering the orbital altitude of the first satellite, control the second satellite to lower an orbital altitude of the second satellite based on the at least one drag modulation parameter to achieve the target separation.

In non-limiting embodiments or aspects, wherein determining the control plan comprises optimizing a trajectory of drag modulation parameters for each satellite based on a target satellite formation. In non-limiting embodiments or aspects, wherein optimizing the trajectory for drag modulation parameters comprises generating a differential-drag sequence for each of the first satellite and the second satellite. In non-limiting embodiments or aspects, wherein controlling the second satellite results in cross-track separation and along-track separation between each of the plurality of satellites. In non-limiting embodiments or aspects, wherein controlling the first satellite comprises altering an angle, orientation, attitude, and/or surface area of the first satellite to alter its drag. In non-limiting embodiments or aspects, the computing device is further configured to: continually determine an updated cross-track orbital control plan for the plurality of satellites at predetermined time or orbital intervals; and control the first satellite and the second satellite based on the updated cross-track orbital control plan. In non-limiting embodiments or aspects, wherein determining the control plan comprises: selecting a value for a change in right ascension of an ascending node of the first satellite or the second satellite; and determining a value for a change in argument of latitude of the first satellite or the second satellite based on the change in right ascension, the control plan is determined based on solving a convex optimization problem based on the value for the change in argument of latitude and/or the value for the change in right ascension.

According to non-limiting embodiments or aspects, provided is a method of controlling a plurality of satellites in orbit, comprising: determining, with at least one processor, a control plan based on a target separation in along-track and cross-track directions for a plurality of satellites comprising at least a first satellite and a second satellite, the control plan comprising at least one drag modulation parameter for each satellite; controlling the first satellite to lower an orbital altitude of the first satellite based on the at least one drag modulation parameter, such that a mean motion and nodal precession rate of the first satellite increases; and based on the control plan and after lowering the orbital altitude of the first satellite, controlling the second satellite to lower an orbital altitude of the second satellite based on the at least one drag modulation parameter to achieve the target separation.

In non-limiting embodiments or aspects, wherein determining the control plan comprises optimizing a trajectory of drag modulation parameters for each satellite based on the target separation. In non-limiting embodiments or aspects, wherein optimizing the trajectory of drag modulation parameters comprises generating a differential-drag sequence for each of the first satellite and the second satellite. In non-limiting embodiments or aspects, wherein controlling the second satellite results in cross-track separation and along-track separation between each of the plurality of satellites. In non-limiting embodiments or aspects, wherein controlling the first satellite comprises altering an angle, orientation, attitude, and/or surface area of the first satellite to alter its drag. In non-limiting embodiments or aspects, further comprising: continually determining, with at least one processor, an updated cross-track orbital control plan for the plurality of satellites at predetermined time or orbital intervals; and controlling the first satellite and the second satellite based on the updated cross-track orbital control plan. In non-limiting embodiments or aspects, wherein determining the cross-track orbital control plan comprises: selecting a value for a change in right ascension of an ascending node of the first satellite or the second satellite; and determining a value for a change in argument of latitude of the first satellite or the second satellite based on the change in right ascension, the control plan is determined based on solving a convex optimization problem based on the value for the change in argument of latitude and/or the value for the change in right ascension. In non-limiting embodiments or aspects, the at least one computing device comprises at least one of the following: a computing device arranged remote from the plurality of satellites and in communication with at least one satellite of the plurality of satellites, a computing device arranged remote from the plurality of satellites and in communication with each satellite of the plurality of satellites, a computing device arranged on-board at least one satellite of the plurality of satellites, or any combination thereof.

According to non-limiting embodiments or aspects, provided is a computer program product for controlling a plurality of satellites in orbit, comprising at least one non-transitory computer-readable medium that, when executed by at least one processor, causes the at least one processor to: determine a control plan based on a target separation in along-track and cross-track directions for a plurality of satellites comprising at least a first satellite and a second satellite, the control plan comprising at least one drag modulation parameter for each satellite; control the first satellite to lower an orbital altitude of the first satellite based on the at least one drag modulation parameter, such that a mean motion and nodal precession rate of the first satellite increases; and based on the control plan and after lowering the orbital altitude of the first satellite, control the second satellite to lower an orbital altitude of the second satellite based on the at least one drag modulation parameter to achieve the target separation.

In non-limiting embodiments or aspects, wherein determining the control plan comprises optimizing a trajectory of drag modulation parameters for each satellite based on a target satellite formation. In non-limiting embodiments or aspects, wherein optimizing the trajectory for drag modulation parameters comprises generating a differential-drag sequence for each of the first satellite and the second satellite. In non-limiting embodiments or aspects, wherein controlling the second satellite results in cross-track separation and along-track separation between each of the plurality of satellites. In non-limiting embodiments or aspects, wherein controlling the first satellite comprises altering an angle, orientation, attitude, and/or surface area of the first satellite to alter its drag.

Other non-limiting embodiments or aspects will be set forth in the following numbered clauses:

Clause 1: A system for controlling a plurality of satellites in orbit, comprising: at least one computing device including at least one processor, the at least one computing device configured to: determine a control plan based on a target separation in along-track and cross-track directions for a plurality of satellites comprising at least a first satellite and a second satellite, the control plan comprising at least one drag modulation parameter for each satellite; control the first satellite to lower an orbital altitude of the first satellite based on the at least one drag modulation parameter, such that a mean motion and nodal precession rate of the first satellite increases; and based on the control plan and after lowering the orbital altitude of the first satellite, control the second satellite to lower an orbital altitude of the second satellite based on the at least one drag modulation parameter to achieve the target separation.

Clause 2: The system of clause 1, wherein determining the control plan comprises optimizing a trajectory of drag modulation parameters for each satellite based on a target satellite formation.

Clause 3: The system of clause 1 or 2, wherein optimizing the trajectory for drag modulation parameters comprises generating a differential-drag sequence for each of the first satellite and the second satellite.

Clause 4: The system of any of clauses 1-3, wherein controlling the second satellite results in cross-track separation and along-track separation between each of the plurality of satellites.

Clause 5. The system of any of clauses 1-4, wherein controlling the first satellite comprises altering an angle, orientation, attitude, and/or surface area of the first satellite to alter its drag.

Clause 6. The system of any of clauses 1-5, wherein the computing device is further configured to: continually determine an updated cross-track orbital control plan for the plurality of satellites at predetermined time or orbital intervals; and control the first satellite and the second satellite based on the updated cross-track orbital control plan.

Clause 7. The system of any of clauses 1-6, wherein determining the control plan comprises: selecting a value for a change in right ascension of an ascending node of the first satellite or the second satellite; and determining a value for a change in argument of latitude of the first satellite or the second satellite based on the change in right ascension, wherein the control plan is determined based on solving a convex optimization problem based on the value for the change in argument of latitude and/or the value for the change in right ascension.

Clause 8: A method of controlling a plurality of satellites in orbit, comprising: determining, with at least one processor, a control plan based on a target separation in along-track and cross-track directions for a plurality of satellites comprising at least a first satellite and a second satellite, the control plan comprising at least one drag modulation parameter for each satellite; controlling the first satellite to lower an orbital altitude of the first satellite based on the at least one drag modulation parameter, such that a mean motion and nodal precession rate of the first satellite increases; and based on the control plan and after lowering the orbital altitude of the first satellite, controlling the second satellite to lower an orbital altitude of the second satellite based on the at least one drag modulation parameter to achieve the target separation.

Clause 9. The method of clause 8, wherein determining the control plan comprises optimizing a trajectory of drag modulation parameters for each satellite based on the target separation.

Clause 10: The method of clause 8 or 9, wherein optimizing the trajectory of drag modulation parameters comprises generating a differential-drag sequence for each of the first satellite and the second satellite.

Clause 11: The method of any of clauses 8-10, wherein controlling the second satellite results in cross-track separation and along-track separation between each of the plurality of satellites.

Clause 12. The method of any of clauses 8-11, wherein controlling the first satellite comprises altering an angle, orientation, attitude, and/or surface area of the first satellite to alter its drag.

Clause 13. The method of any of clauses 8-12, further comprising: continually determining, with at least one processor, an updated cross-track orbital control plan for the plurality of satellites at predetermined time or orbital intervals; and controlling the first satellite and the second satellite based on the updated cross-track orbital control plan.

Clause 14. The method of any of clauses 8-13, wherein determining the cross-track orbital control plan comprises: selecting a value for a change in right ascension of an ascending node of the first satellite or the second satellite; and determining a value for a change in argument of latitude of the first satellite or the second satellite based on the change in right ascension, wherein the control plan is determined based on solving a convex optimization problem based on the value for the change in argument of latitude and/or the value for the change in right ascension.

Clause 15. The method of any of clauses 8-14, wherein the at least one computing device comprises at least one of the following: a computing device arranged remote from the plurality of satellites and in communication with at least one satellite of the plurality of satellites, a computing device arranged remote from the plurality of satellites and in communication with each satellite of the plurality of satellites, a computing device arranged on-board at least one satellite of the plurality of satellites, or any combination thereof.

Clause 16: A computer program product for controlling a plurality of satellites in orbit, comprising at least one non-transitory computer-readable medium that, when executed by at least one processor, causes the at least one processor to: determine a control plan based on a target separation in along-track and cross-track directions for a plurality of satellites comprising at least a first satellite and a second satellite, the control plan comprising at least one drag modulation parameter for each satellite; control the first satellite to lower an orbital altitude of the first satellite based on the at least one drag modulation parameter, such that a mean motion and nodal precession rate of the first satellite increases; and based on the control plan and after lowering the orbital altitude of the first satellite, control the second satellite to lower an orbital altitude of the second satellite based on the at least one drag modulation parameter to achieve the target separation.

Clause 17. The computer program product of clause 16, wherein determining the control plan comprises optimizing a trajectory of drag modulation parameters for each satellite based on a target satellite formation.

Clause 18: The computer program product of clause 16 or 17, wherein optimizing the trajectory for drag modulation parameters comprises generating a differential-drag sequence for each of the first satellite and the second satellite.

Clause 19. The computer program product of any of clauses 16-18, wherein controlling the second satellite results in cross-track separation and along-track separation between each of the plurality of satellites.

Clause 20. The computer program product of any of clauses 16-19, wherein controlling the first satellite comprises altering an angle, orientation, attitude, and/or surface area of the first satellite to alter its drag.

### BRIEF DESCRIPTION OF THE DRAWINGS

Additional advantages and details are explained in greater detail below with reference to the exemplary embodiments that are illustrated in the accompanying schematic figures, in which:

FIG. 1A-1C are schematic diagrams of a system for controlling satellites in orbit according to non-limiting embodiments;

FIG. 2 is a flow diagram of a method for controlling satellites in orbit according to non-limiting embodiments;

FIG. 3 illustrates experimental data based on non-limiting embodiments of a system and method for controlling satellites in orbit; and

FIG. 4 illustrates example components of a computing device used in connection with non-limiting embodiments.

### DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments or aspects of the invention. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the terms “communication” and “communicate” refer to the receipt or transfer of one or more signals, messages, commands, or other type of data. For one unit (e.g., any device, system, or component thereof) to be in communication with another unit means that the one unit is able to directly or indirectly receive data from and/or transmit data to the other unit. This may refer to a direct or indirect connection that is wired and/or wireless in nature. Additionally, two units may be in communication with each other even though the data transmitted may be modified, processed, relayed, and/or routed between the first and second unit. For example, a first unit may be in communication with a second unit even though the first unit passively receives data and does not actively transmit data to the second unit. As another example, a first unit may be in communication with a second unit if an intermediary unit processes data from one unit and transmits processed data to the second unit. It will be appreciated that numerous other arrangements are possible.

As used herein, the term “computing device” may refer to one or more devices configured to process data. A computing device may, in some examples, include the necessary components to receive, process, and output data, such as a processor, a display, a memory, an input device, a network interface, and/or the like. A computing device may be a processor, such as a CPU or GPU, a mobile device, and/or other like devices. A computing device may also be a desktop computer, a server computer or other form of non-mobile computer. Reference to “a processor,” as used herein, may refer to a previously-recited processor that is recited as performing a previous step or function, a different processor, and/or a combination of processors. For example, as used in the specification and the claims, a first processor that is recited as performing a first step or function may refer to the same or different processor recited as performing a second step or function.

Non-limiting embodiments described herein are directed to systems, methods, and devices for controlling satellites in orbit to form a target separation (e.g., target satellite formation) in both along-track and cross-track directions. Non-limiting embodiments may be used for coordinated sensing, radio navigation, wildlife tracking, three-dimensional imaging, remote sensing, and/or any other application using multiple satellites. As an example, cross-track and along-track separation may be desired in radio navigation applications to allow for differentiation among signals from each of multiple satellites. Non-limiting embodiments provide for controlling satellites without the need for propulsion systems on the satellites. By determining a control plan that includes drag modulation parameters, non-limiting embodiments allow for along-track and cross-track separation according to a target separation without needing propulsion systems. Further, non-limiting embodiments allow for multiple satellites to be launched at the same time and later separated, thereby reducing the number of launches necessary.

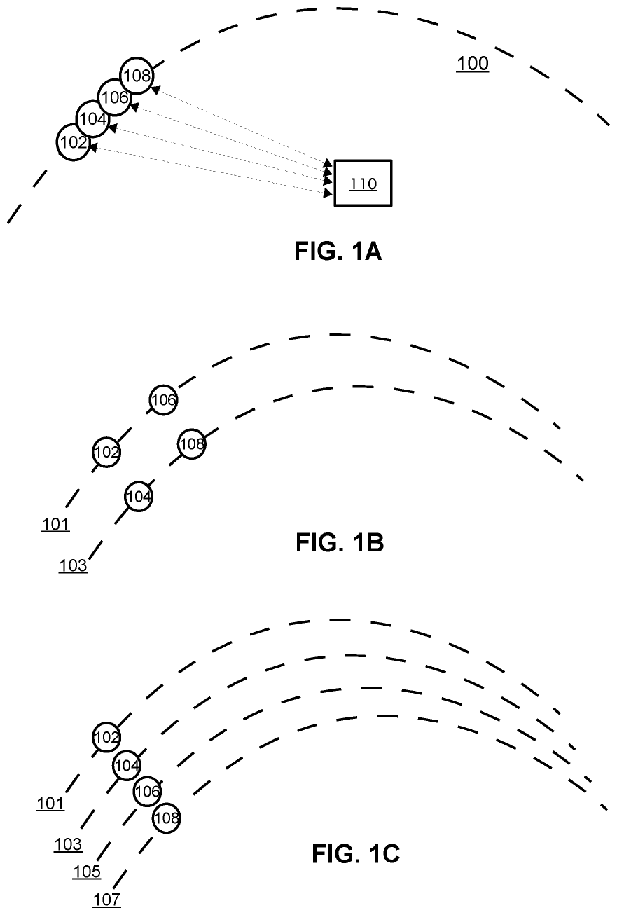

FIGS. 1A, 1B, and 1C depict a system 1000 for controlling satellites according to non-limiting embodiments. FIG. 1A shows an initial arrangement of satellites 102, 104, 106, 108 on an orbital track 100. The satellites 102, 104, 106, 108 shown show along-track separation (separation on the same orbital track). FIG. 1B shows a target separation arrangement of satellites 102, 104, 106, 108 on a first orbital track 101 and a second orbital track 103 that is lateral from the first orbital track 101, showing cross-track separation between satellites 102, 106 and satellites 104, 108 in the shape of a box. FIG. 1C shows another target separation arrangement of satellites 102, 104, 106, 108 on a first orbital track 101, a second orbital track 103 that is lateral from the first orbital track 101, a third orbital track 105 that is lateral from the first and second orbital tracks 101, 103, and a fourth orbital track 107 that is lateral from the first, second, and third orbital tracks 101, 103, 105, showing cross-track separation between each of satellites 102, 104, 106, 108 in a line formation. It will be appreciated that a target formation of satellites may include any number of satellites and/or any number of formations, and that the examples shown in FIGS. 1A, 1B, and 1C are non-limiting embodiments. Additional satellites, orbital tracks, and/or formations may be used.

With reference to FIG. 1A, a computing device 110 may be arranged on the ground (e.g., on Earth) and/or on-board one or more of the satellites. The example shown in FIG. 1A depicts one computing device 110 remote from and in communication with each of the satellites 102, 104, 106, 108. It will be appreciated that, in non-limiting embodiments, multiple computing devices may be used. It will also be appreciated that, in non-limiting embodiments, the computing device 110 may communicate with one or more satellites 102, 104, 106, 108, and the satellite in communication with the computing device 110 (e.g., satellite 102) may relay communications to the other satellites (e.g., 104, 106, 108). Additionally or alternatively, one or more satellites 102, 104, 106, 108 may include one or more on-board computing devices, and one or a subset (e.g., 102) may act as a primary device that communicates with and/or controls the others (e.g., 104, 106, 108).

In operation, computing device 110 may communicate with and/or receive data from the satellites including, for example, altitude, velocity, acceleration, drag, and/or the like. The computing device 110 may process the data to determine an optimized cross-track orbital control plan that includes control parameters to alter an initial formation of satellites (e.g., such as shown in FIG. 1A) to a target formation of satellites (e.g., such as shown in FIG. 1B and FIG. 1C). The target formation may include cross-track separation between one or more satellites. The control parameters may include, for one or more of a plurality of satellites, a target altitude, right of ascension, argument of latitude, time period, and/or the like. The control parameters may be communicated to the satellites 102, 104, 106, 108 from the computing device 110 in non-limiting embodiments in which the computing device 110 is remote from one or more of the satellites 102, 104, 106, 108.

Starting with the formation of satellites 102, 104, 106, 108 shown in FIG. 1A (e.g., on the same orbital track 100), a set of control parameters may be determined by the computing device 110. Those control parameters may be implemented by lowering an orbital altitude of one or more satellites (e.g., 102, 106) by, for example, modulating the drag of the satellites 102, 106. The drag may be modulated by altering an angle of the satellite or portion thereof by, for example, activating a mechanical device (e.g., such as a motor attached to a wheel), moving a solar panel, and/or the like. In some non-limiting embodiments, propulsion systems may additionally and/or alternatively be used to lower the orbital altitude of one or more satellites. Those skilled in the art will appreciate that various techniques for lowering the altitude of a satellite may be used.

Once the orbital altitude of the first satellite(s) (e.g., satellites 102, 106) is lowered, the computing device 110 may wait for a time period to elapse before lowering the orbital altitude of one or more second satellites (e.g., satellites 104, 108). Over time, the lower altitude of the first satellite(s) will result in cross-track separation such that the satellite(s) (e.g., 102, 106) are traveling on an orbital track 101 that is lower than and lateral to the original orbital track 100 the satellite(s) were traveling on. After the time period elapses, the second satellite(s) are lowered in altitude (e.g., which may be the same altitude as the first satellite(s)), resulting in the second satellite(s) traveling on an orbital track 103 that is lateral to the orbital track 101 on which the first satellite(s) are traveling. In non-limiting embodiments the satellites 102, 104, 106, 108 may be continually moved with newly-generated drag modulation parameters over time to align into a target formation.

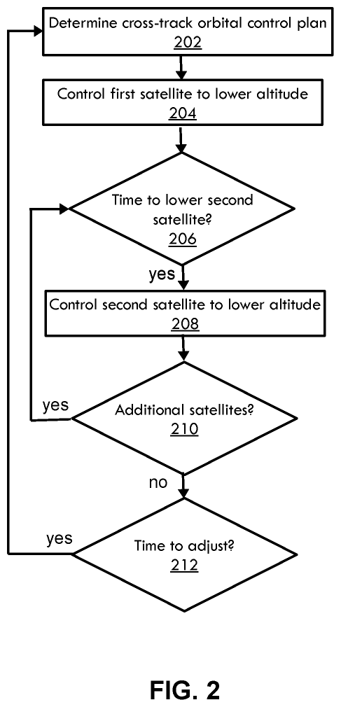

Referring now to FIG. 2, a method for controlling satellites is shown according to non-limiting embodiments. It will be appreciated that the order of the steps shown in FIG. 2 is for illustrative purposes only and that non-limiting embodiments may involve more steps, fewer steps, different steps, and/or a different order of steps. In non-limiting embodiments, one or more steps may be automatically performed in response to performance and/or completion of a preceding step. At a first step 202, a control plan for a plurality of satellites is determined by one or more computing devices. The control plan may include at least one drag modulation parameter for each satellite of the plurality of satellites. The control plan may also include at least one temporal parameter, such as a time period, a condition, and/or the like. Determining the control plan may include optimizing a trajectory of drag modulation parameters for each satellite based on a target separation (e.g., target satellite formation) in both along-track and cross-track directions.

At a next step 204, one or more first satellite(s) are controlled by one or more computing devices to lower an orbital altitude of the satellite(s). For example, a satellite traveling in an orbital track with other satellites may be subjected to one or more forces, by a mechanical device or the like, to alter the drag of the satellite. This may involve altering an angle, orientation, attitude, and/or surface area of the first satellite(s). The first satellite(s) may be controlled by one or more computing devices remote from the satellite(s) (e.g., such as a computing device on the ground) and/or one or more on-board computing devices (e.g., such as a computing device arranged in a satellite). Such control methods may be performed substantially simultaneously with multiple satellites or just a single satellite, such that the first satellite(s) will eventually be on a separate orbital track than the others of the plurality based on a target separation.

At step 206, one or more computing devices determines when to lower one or more second satellite(s) based on a temporal parameter. The temporal parameter may be an orbital control plan parameter determined at step 202. For example, the temporal parameter may be a time period that elapses following the lowering of the first satellite(s). As another example, the temporal parameter may be based on a value (e.g., a target cross-track separation and/or along-track separation) being reached over a time period. At a time following the lowering of the first satellites, the one or more computing devices determine to lower the second satellite(s) and proceed to step 208.

At step 208, one or more second satellite(s) are controlled to lower an orbital altitude of the satellite(s). The lower orbital altitude may be same or different altitude than the orbital altitude of the first satellite(s) from step 204. For example, a satellite traveling in an orbital track with other satellites may be subjected to one or more forces, by a mechanical device or the like, to alter the drag of the satellite. This may involve altering an angle, orientation, attitude, and/or surface area of the second satellite(s). The second satellite(s) may be controlled by one or more computing devices remote from the satellite(s) (e.g., such as a computing device on the ground) and/or one or more on-board computing devices (e.g., such as a computing device arranged in a satellite). Such control methods may be performed substantially simultaneously with multiple satellites or just a single satellite, such that the second satellite(s) is lowered to the altitude of the first satellite(s) or a desired altitude.

At step 210, a computing device determines if there are additional satellites to lower. For example, there may be a plurality of satellites and/or groups of satellites that are lowered over multiple iterations to result in multiple orbital tracks. If there are additional satellites to control, the method may look back to step 206. If there are not additional satellites, the method may end and/or proceed to step 212. At step 212, the computing device determines if the formation (e.g., constellation) of satellites should be adjusted. This determination may be based on a temporal parameter (e.g., every predetermined interval) or may be performed in response to the formation of the satellites deviating from the target satellite separation by at least a threshold amount. Accordingly, the method may loop back to step 202 to repeat the process one or more times with a different control plan.

In non-limiting embodiments, determining the control plan includes optimizing a trajectory of drag modulation parameters. It will be appreciated by those skilled in the art that there are various ways to determine a control plan of drag modulation parameters based on a target satellite separation, and that the specific equations and methods described herein relate to non-limiting embodiments.

The unperturbed Keplerian dynamics of a satellite orbiting around the Earth are described by the two-body equation:

$$\ddot{r} = - \frac{μ}{{r}^{3}} r \qquad ( 1 )$$

where r is the position vector of the satellite in the Earth-centered inertial frame, \ddot{r} is the acceleration vector, and μ is the Earth's gravitational parameter. Equation (1) assumes that the spacecraft is influenced only by the spherically symmetric gravitational field of the Earth. However, in reality a satellite experiences secondary perturbation forces. A perturbation force on a satellite in low earth orbit (LEO) are due to atmospheric drag and the Earth's non-spherical gravitational field. To account for perturbations, Equation (1) can be written as:

$$\ddot{r} = - \frac{μ}{{r}^{3}} r + p \qquad ( 2 )$$

where p is the perturbative acceleration vector of the satellite. The orbital state of a satellite is described using six quantities known as the orbital elements. The orbital elements are: α, the semi-major axis; e, the eccentricity of the orbit ellipse; i, the inclination; Ω, the right ascension of the ascending node (RAAN); ω, the argument of periapsis; and v, the true anomaly. With circular orbits, e=0 and ω is undefined. Since v is referenced from ω, it is poorly defined. Instead, non-limiting embodiments described herein utilize the argument of latitude (AoL), represented by θ, which measures along-track orbital position from the equatorial plane.

In LEO, atmospheric drag may be modeled by:

$$D = - \frac{1}{2 m} ρ A {C}_{D} v ( v - {v}_{at m} ) \qquad ( 3 )$$

where D is the drag force, p is the atmospheric density, A is the incident cross-sectional area of the satellite, CD is the drag coefficient, m is the satellite mass, v is the inertial velocity vector of the satellite, Vₐₜₘ is the velocity of the atmosphere, and v=∥v−v vaₜₘ∥ is the relative velocity vector magnitude. According to Equation (3), the drag force increases with atmospheric density; however, drag can also be modulated by changing the cross-sectional area of the satellite. The cross-sectional area can be modified through deployable panels, by changing the satellite attitude, angle, orientation, and/or surface area, and/or the like. Drag acts in the direction opposing velocity, and therefore directly affects the motion of a satellite within the orbital plane, decreasing its total orbital energy. In the orbital plane, drag enters the dynamic equations for eccentricity and the semi-major axis. Drag circularizes an orbit, decreasing its eccentricity. The eccentricity dynamics due to drag are not considered when using circular orbits for the purpose of calculation. The semi-major axis dynamics due to drag are:

$$\dot{a} = 2 \sqrt{\frac{{a}^{3}}{λ}} D \qquad ( 5 )$$

where D=∥D∥ is the magnitude of the drag vector.

In non-limiting embodiments, nodal precession is used to determine the control plan. The Earth is not a perfect sphere, but rather resembles an oblate spheroid; this causes the gravitational field of the Earth to deviate from the point mass model in Equation (1). Models of the gravitational field of Earth are expressed by a spherical harmonic expansion with coefficients J*. In non-limiting embodiments, a simple model based on the first non-trival term, J₂, may be used. Such a model captures the dominating effect of the Earth's oblateness and is three orders of magnitude larger than the next spherical harmonic term. In addition, the J₂ model is rotationally symmetric around the Earth so it only requires knowledge of an orbit's inclination. This makes it consistent across all possible RAAN angles and separations in a formation. On short timescales, the J₂ perturbation affects all the orbital elements. However, on long timescales it introduces only a mean variation on Ω, and averages to zero for θ. The mean RAAN is denoted as Ω̅ and the mean AoL θ̅. The mean dynamics of these values are:

$$\dot{\overline{Ω}} = - [ \frac{3}{2} \frac{{J}_{2} \sqrt{μ} {R}_{E}^{2}}{{a}^{7 / 2}} ] cos i \qquad ( 6 )$$

$$\dot{\overline{θ}} = \sqrt{μ / {a}^{3}} \qquad ( 7 )$$

where R_{E} is the Earth's equatorial radius.

From Equations (6) and (7), the nodal precession rate and the AoL rate are both functions of the semi-major axis. The semi-major axis can be modulated through drag variation (e.g., Equation (3)). Therefore, drag modulation can be used to affect changes in the AoL and RAAN for a satellite and establish satellite formations with coplanar and non-coplanar separations.

In non-limiting embodiments, determining a control plan includes forming a linear dynamics model and optimizing the trajectory of drag modulation parameters for controlling the satellites.

In non-limiting embodiments, using a first-order Taylor expansion, Equations (6) and (7) are linearized with respect to a referenced semi-major axis, a, and Equation (3) can be linearized with respect to a reference drag, D, as:

$$Δ \dot{\overline{θ}} = - \frac{3}{2} \sqrt{\frac{μ}{{a}^{5}}} Δ a {=}^{Δ} {k}_{1} Δ a \qquad ( 8 )$$

$$Δ \dot{a} = 2 \sqrt{\frac{{a}^{3}}{μ}} D Δ D {=}^{Δ} {k}_{3} Δ D \qquad ( 9 )$$

$$Δ \dot{\overline{Ω}} = \frac{21}{4} {J}_{2} \sqrt{\frac{μ}{{a}^{9}}} {R}_{E}^{2} cos i Δ a {=}^{Δ} {k}_{2} Δ a . \qquad ( 10 )$$

According to Equations (8) and (10), the rates of Aθ̅ and ΔΩ̅ are both governed by Δα, so the rates cannot be altered independently of each other. Assuming Δθ̅=ΔΩ̅=0 initially, any Δθ achieved results in:

$$Δ \overline{Ω} = \frac{{k}_{2}}{{k}_{1}} Δ \overline{θ} {=}^{Δ} {k}_{4} Δ \overline{θ} \qquad ( 11 )$$

where k4=k₂/k₁ is a dimensionless constant that depends only on the reference orbit. The linear equations in Equations (8) to (10) can be put in the standard form of a linear dynamical system:

$$\dot{x} = Ax + Bu \qquad ( 12 )$$

where

$$x = [ \begin{matrix}Δ \overline{θ} \\ Δ a\end{matrix} ] , A = [ \begin{matrix}0 & {k}_{1} \\ 0 & 0\end{matrix} ] , B = [ \begin{matrix}0 \\ {k}_{3}\end{matrix} ] \qquad ( 14 )$$

and where u=[ΔD]. The value of ΔΩ̅ is omitted from the state since Equation (11) establishes a relationship between ΔΩ̅ and Δθ̅. To extend this method to the case of n−2 satellites, the first satellite is chosen as the chief satellite, and the other satellite A states are all referenced to the chief satellite. The computing device may concatenate n−1 copies of Equation (14) to rewrite Equation (12) as a 2(n−1) state system. When referring to the relative state between the chief satellite and another satellite, the notation Δα^{1-p} and Δθ^{1-p} may be used, where p is the index of the satellite from the plurality of satellites.

Given a pair of satellites deployed at the same or substantially the same initial orbit (i.e., x₀=0, or near 0), the differential drag ΔD is manipulated over time to achieve a final formation configuration x_{f} (e.g., a target satellite formation) at some future time t_{f}. The orbital altitude of one satellite is lowered such that its nodal precession rate is larger than the other satellite. The satellites then remain in this configuration, with ΔD=0, or near 0 until a desired Δθ̅, and therefore a desired ΔΩ̅, is achieved, at which time and in response to which the higher satellite is controlled to lower its altitude to match or substantially match the first satellite.

To maintain a fixed final formation configuration, the value of x_{f} is maintained at zero or near zero. To satisfy this, Equations (8) to (10) show that Δα_{f} and ΔD_{f} are also zero or near zero, such that the satellites are at the same final altitude and in the same drag configuration. Modifying Equation (11) to account for the fact that Δθ̅ is an angular quantity, the possible ΔΩ̅ for a desired final Δθ̅ are given by:

$$Δ {\overline{Ω}}_{f} = {k}_{4} ( Δ {\overline{θ}}_{f} + 2 π ℓ ) \qquad ( 15 )$$

where l is any integer. To first order, Equation (15) defines the argument of latitude and right ascension separations achievable using drag modulation. For differential-drag formation control to be feasible, Equation (15) may be used as a limit when selecting the final Δθ̅ and ΔΩ̅ of a formation.

Given n satellites deployed in the same orbit (i.e., x₀=0), it is desired to maneuver these satellites into a target separation (e.g., formation configuration) at a final time t_{f}. To do so with differential drag, the final state x_{f} is chosen by choosing the desired value for either ΔΩ_{f} or Δθ_{f} and selecting the other in accordance to Equation (15). The final altitude or final time are then a result of this choice. It then remains to determine the necessary control inputs to achieve this target formation.

In non-limiting embodiments, a full trajectory of drag modulation inputs that drives the satellite formation from x₀ to x_{f} may be planned as a control plan by solving the convex optimization problem:

$$\begin{matrix}{minimize}_{{x}_{1 : N} , {u}_{1 : N - 1}} & {g}_{f} ( {x}_{N} ) + {\sum }_{i = 1}^{N - 1} g ( {x}_{i} , {u}_{i} ) \\ subject to & {x}_{i + 1} = {Ax}_{i} + {Bu}_{i} , \\ & [ Δ {a}_{N}^{1 - 2} , … , Δ {a}_{N}^{1 - n} ] = 0 , \\ & Δ {a}_{m i n} \leq [ Δ {a}_{i}^{1 - 2} , … , Δ {a}_{i}^{1 - n} ] \leq Δ {a}_{m ax} , \\ & {u}_{m i n} \leq {u}_{i} \leq {u}_{m ax}\end{matrix} \qquad ( 16 )$$

where g(x, u) is a convex stage cost function, and g_{f}(x) is a convex terminal cost function. The first constraint enforces the discretized form of the linear dynamics from Equation (12), the second constraint ensures the satellites end at the same final altitude, the third constraint restricts the minimum and maximum altitude differences for each couple of satellites to be within Δαₘᵢₙ and Δαₘₐₓ, and the final constraint enforces uₘᵢₙ and uₘₐₓ as lower and upper bounds on the drag achievable by each satellite. In non-limiting embodiments, meeting the Δθ final conditions is not treated as a constraint but included in the cost function, thereby relaxing the problem and avoiding ill-conditioning.

In non-limiting embodiments, the cost functions g and g_{f} can be chosen to shape the overall system behavior. To produce minimum-time bang-bang control commands, L₁ costs can be used:

$${g}_{f} ( {x}_{N} ) = {‖ Δ {\overline{θ}}_{N}^{1 - 2} - Δ {\overline{θ}}_{f}^{1 - 2} ‖}_{1} + … + {‖ Δ {\overline{θ}}_{N}^{1 - n} - Δ {\overline{θ}}_{f}^{1 - n} ‖}_{1} \qquad ( 17 )$$

$$g ( x , u ) = {‖ Δ {\overline{θ}}^{1 - 2} - Δ {\overline{θ}}_{f}^{1 - 2} ‖}_{1} + … + {‖ Δ {\overline{θ}}^{1 - n} - Δ {\overline{θ}}_{f}^{1 - n} ‖}_{1} + {‖ {u}_{1} ‖}_{1} + {‖ {u}_{2} ‖}_{1} + … + {‖ {u}_{n} ‖}_{1} .$$

Other convex cost functions, such as a quadratic cost, may be used in non-limiting embodiments.

The convex optimization problem in Equation (16) with the cost function in Equation (17) is a linear program and can be solved with many standard solvers. Experiments were performed to consider a formation of satellites in which each satellite is a 1.5 kg CubeSat with a 15 cm×10 cm×10 cm chassis and equipped with two deployable solar panels, each with dimension 20 cm×15 cm×0.3 cm. The drag ratio of the satellite is 7.5:1. For purposes of the experiments, a 5:1 drag ratio was used, which results in setting the input limits, uₘᵢₙ and uₘₐₓ, of Equation (16) to 0.2 and 1, respectively. It will be appreciated that the experimental data described herein is meant as an example of non-limiting embodiments, and that the data may change with different types and sizes of satellites, different control algorithms, and/or the like.

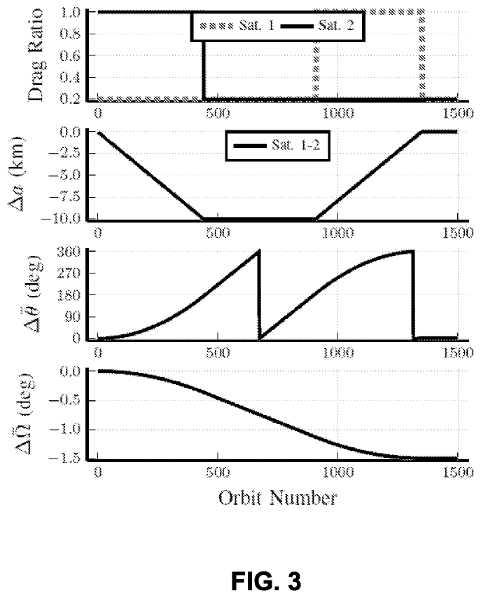

In the experiment, Equation (16) is solved for a pair of satellites deployed at 440 km altitude and with an inclination of 51.5°, which are conditions that approximate deployment from the International Space Station (ISS)). The final conditions are set to Δθ̅_{f}=0 and l=2. From Equation (15), this results in ΔΩ̅^{f}=1.4°, a spherical distance of 165 km. In this scenario, the altitude limits, Δαₘᵢₙ and Δαₘₐₓ, are set to 10 km. The results of a single, 1500 orbit time horizon, trajectory optimization for these conditions are shown in FIG. 3. The top plot shows the drag control trajectory for the two satellites. To increase the relative AoL and RAAN, the orbital altitude of the second satellite is decreased first. The bottom three plots show the change in Δα, Δθ̅, and ΔΩ̅, respectively. From these plots we can see that the the relative AoL increases by 720°, or two full orbits, and that the first satellite lowers its altitude to exactly reach Δθ̅_{f}=0. We can also see that the 10 km altitude constraint was satisfied. This optimization took 0.8s to solve on a MacBook Pro with an Apple M1 Pro processor.

To capture the effect of realistic modeling errors and disturbances, closed-loop simulations are performed using nonlinear dynamics with additional perturbations not modeled in Equation (12). Specifically, the effects of the Earth's rotation on drag, the first five zonal harmonics (J₁-J₆) for gravity, and a small eccentricity, e=0.005, of the initial orbit are considered. To successfully execute planned maneuvers in the presence of modeling errors and disturbances, solutions to Equation (16) may be computed in a receding-horizon or model-predictive control (MPC) loop. On each loop, the optimization problem is solved using the current measured state of the satellite formation, and the computed control inputs are applied over the next timestep. The repeated solving corrects for disturbances on the satellite. The timesteps of the control loop are on the order of one to five orbital periods.

This receding-horizon control algorithm is used to solve two scenarios, a line formation (e.g., an example depicted in FIG. 1C) and a box formation (e.g., an example depicted in FIG. 1B). The initial state is chosen to approximate deployment with two common Cube-Sat deployment methods: the ISS and a SpaceX® Transporter launch. Both scenarios assume that all of the satellites have the same drag ratio and the same initial state.

Scenario 1 (Line Formation): Scenario 1 assumes that four satellites are deployed from the ISS, with an altitude of 440 km, eccentricity of 0.005, and inclination of 51.5°. The goal is to maneuver the satellites to be equally distributed in the cross-track direction with zero change in AoL so they pass over the equator in a line. This corresponds to Δθ̅_{f}=0 and ΔΩ̅_{f}=k42πl with l=1, 2, 3. In this scenario, the receding-horizon control policy is re-solved once per orbit over a time horizon of 1400 orbits and the altitude limits Δαₘᵢₙ and Δαₘₐₓ were set to 100 km. The results of the first scenario are presented in Table 1. The final orbit has a 385.5 km altitude, eccentricity of 0.002, and inclination of 51.49°. The fourth satellite, the satellite that aims to reach the largest ΔΩ̅, drives the overall differential drag required for the formation. When the altitude rate is steeper, the satellite is in a high drag configuration. Contrarily, where the altitude rate is shallower, the satellite is in a low drag configuration. The AoL and RAAN difference for the three satellite pairs may be calculated with respect to the chief satellite. Table I reports the overall maneuver time, the final difference in the AoL and the RAAN, and the spherical distance between the chief satellite and the other satellite. It takes three months to reach the final configuration, and the maximum distance between two satellites is 268.2 km.

TABLE I

| | | | | Spherical |
|---|---|---|---|---|
| Pair | t_{f}, months | Δθ_{f}, deg | ΔΩ_{f}, deg | Distance, km |
| Sat. 1-2 | 3 | 0 | −0.75 | 89.26 |
| Sat. 1-3 | | −0.008 | −1.5 | 178.7 |
| Sat. 1-4 | | −0.213 | −2.25 | 268.2 |

Scenario 2 (Square/Box Formation): The second scenario assumes that four satellites are deployed from an approximately sun-synchronous SpaceX® Transporter launch, corresponding to an altitude of 550 km, an eccentricity of 0.005, and an inclination of 98°. The goal is to maneuver the satellites to be distributed in AoL and RAAN to form the vertices of a square, as shown in FIG. 1B. For this scenario, the l values are 0, 6, and 6, while the Δθ̅_{f} are 0.03, 0, and 0.03. The receding-horizon control policy is re-solved every five orbits over a time horizon of 5000 orbits.

The results of scenario 2 are presented in Table II. The final orbit has a 518.1 km altitude, eccentricity of 0.0022, and inclination of 98°. The difference was evaluated with respect to the chief satellite. Table II reports the overall maneuver time, the AoL and RAAN final differences, and the spherical distance between the chief satellite and every other satellite. This scenario takes longer than the first scenario; however, the results show that in less advantageous initial conditions a satellite formation with both along-track and cross-track separations can be established using the drag-based method described herein. Furthermore, the algorithm can define the control trajectory in the presence of disturbances and modeling errors.

TABLE II

| | | | | Spherical |
|---|---|---|---|---|
| Pair | t_{f}, months | Δθ_{f}, deg | ΔΩ_{f}, deg | Distance, km |
| Sat. 1-2 | 10.8 | 10.78 | 0.005 | 1300.78 |
| Sat. 1-3 | | −0.03 | 0.965 | 114.12 |
| Sat. 1-4 | | 10.85 | 0.95 | 1317.45 |

Based on the experiments with the two example scenarios, lower orbits, like the ISS orbit, result in faster natural orbital decay due to drag, reducing the possible altitude change. However, the lower inclination for the ISS results in a larger k₄ and faster ΔΩ̅ rate of 0.745° per 2π revolution of Δθ̅. Contrarily, deployment from the SpaceX® Transporter allows a larger available overall altitude change but a smaller ΔΩ̅ rate of 0.16° per 2π revolution of Δθ̅. This is why the second scenario takes longer to complete than the first. The effectiveness of differential drag for cross-track formation control is dependent on orbital inclination.

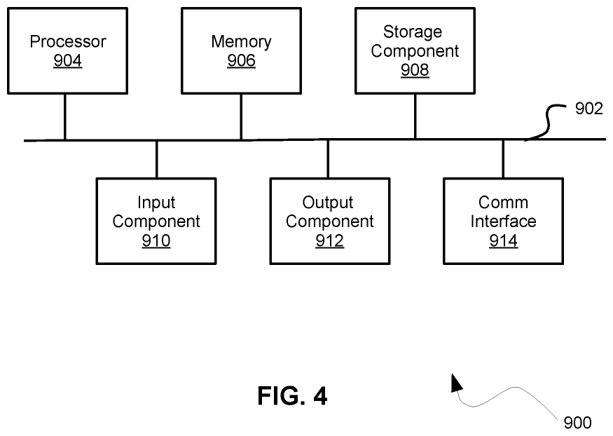

Referring now to FIG. 4, shown is a diagram of example components of a computing device 900 for implementing and performing the systems and methods described herein according to non-limiting embodiments. For example, the computing device 900 may correspond to the computing device 110 shown in FIG. 1A. In some non-limiting embodiments, device 900 may include additional components, fewer components, different components, or differently arranged components than those shown in FIG. 4. Device 900 may include a bus 902, a processor 904, memory 906, a storage component 908, an input component 910, an output component 912, and a communication interface 914. Bus 902 may include a component that permits communication among the components of device 900. In some non-limiting embodiments, processor 904 may be implemented in hardware, firmware, or a combination of hardware and software. For example, processor 904 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 906 may include random access memory (RAM), read only memory (ROM), and/or another type of dynamic or static storage device (e.g., flash memory, magnetic memory, optical memory, etc.) that stores information and/or instructions for use by processor 904.

With continued reference to FIG. 4, storage component 908 may store information and/or software related to the operation and use of device 900. For example, storage component 908 may include a hard disk (e.g., a magnetic disk, an optical disk, a magneto-optic disk, a solid state disk, etc.) and/or another type of computer-readable medium. Input component 910 may include a component that permits device 900 to receive information, such as via user input (e.g., a touch screen display, a keyboard, a keypad, a mouse, a button, a switch, a microphone, etc.). Additionally, or alternatively, input component 910 may include a sensor for sensing information (e.g., a photo-sensor, a thermal sensor, an electromagnetic field sensor, a global positioning system (GPS) component, an accelerometer, a gyroscope, an actuator, etc.). Output component 912 may include a component that provides output information from device 900 (e.g., a display, a speaker, one or more light-emitting diodes (LEDs), etc.). Communication interface 914 may include a transceiver-like component (e.g., a transceiver, a separate receiver and transmitter, etc.) that enables device 900 to communicate with other devices, such as via a wired connection, a wireless connection, or a combination of wired and wireless connections. Communication interface 914 may permit device 900 to receive information from another device and/or provide information to another device. For example, communication interface 914 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 900 may perform one or more processes described herein. Device 900 may perform these processes based on processor 904 executing software instructions stored by a computer-readable medium, such as memory 906 and/or storage component 908. A computer-readable medium may include any non-transitory memory device. A memory device includes memory space located inside of a single physical storage device or memory space spread across multiple physical storage devices. Software instructions may be read into memory 906 and/or storage component 908 from another computer-readable medium or from another device via communication interface 914. When executed, software instructions stored in memory 906 and/or storage component 908 may cause processor 904 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “programmed or configured,” as used herein, refers to an arrangement of software, hardware circuitry, or any combination thereof on one or more devices.

Although embodiments have been described in detail for the purpose of illustration, it is to be understood that such detail is solely for that purpose and that the disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

1. A system for controlling a plurality of satellites in orbit, comprising:
at least one computing device including at least one processor, the at least one computing device configured to:
determine a control plan based on a target separation in along-track and cross-track directions for a plurality of satellites comprising at least a first satellite and a second satellite, the control plan comprising at least one drag modulation parameter for each satellite;
control the first satellite to lower an orbital altitude of the first satellite based on the at least one drag modulation parameter, such that a mean motion and nodal precession rate of the first satellite increases; and
based on the control plan and after lowering the orbital altitude of the first satellite, control the second satellite to lower an orbital altitude of the second satellite based on the at least one drag modulation parameter to achieve the target separation.

2. The system of claim 1, wherein determining the control plan comprises optimizing a trajectory of drag modulation parameters for each satellite based on a target satellite formation.

3. The system of claim 2, wherein optimizing the trajectory for drag modulation parameters comprises generating a differential-drag sequence for each of the first satellite and the second satellite.

4. The system of claim 1, wherein controlling the second satellite results in cross-track separation and along-track separation between each of the plurality of satellites.

5. The system of claim 1, wherein controlling the first satellite comprises altering an angle, orientation, attitude, and/or surface area of the first satellite to alter its drag.

6. The system of claim 1, wherein the computing device is further configured to:
continually determine an updated cross-track orbital control plan for the plurality of satellites at predetermined time or orbital intervals; and
control the first satellite and the second satellite based on the updated cross-track orbital control plan.

7. The system of claim 1, wherein determining the control plan comprises:
selecting a value for a change in right ascension of an ascending node of the first satellite or the second satellite; and
determining a value for a change in argument of latitude of the first satellite or the second satellite based on the change in right ascension,
wherein the control plan is determined based on solving a convex optimization problem based on the value for the change in argument of latitude and/or the value for the change in right ascension.

8. A method of controlling a plurality of satellites in orbit, comprising:
determining, with at least one processor, a control plan based on a target separation in along-track and cross-track directions for a plurality of satellites comprising at least a first satellite and a second satellite, the control plan comprising at least one drag modulation parameter for each satellite;
controlling the first satellite to lower an orbital altitude of the first satellite based on the at least one drag modulation parameter, such that a mean motion and nodal precession rate of the first satellite increases; and
based on the control plan and after lowering the orbital altitude of the first satellite, controlling the second satellite to lower an orbital altitude of the second satellite based on the at least one drag modulation parameter to achieve the target separation.

9. The method of claim 8, wherein determining the control plan comprises optimizing a trajectory of drag modulation parameters for each satellite based on the target separation.

10. The method of claim 9, wherein optimizing the trajectory of drag modulation parameters comprises generating a differential-drag sequence for each of the first satellite and the second satellite.

11. The method of claim 8, wherein controlling the second satellite results in cross-track separation and along-track separation between each of the plurality of satellites.

12. The method of claim 8, wherein controlling the first satellite comprises altering an angle, orientation, attitude, and/or surface area of the first satellite to alter its drag.

13. The method of claim 8, further comprising:
continually determining, with at least one processor, an updated cross-track orbital control plan for the plurality of satellites at predetermined time or orbital intervals; and
controlling the first satellite and the second satellite based on the updated cross-track orbital control plan.

14. The method of claim 8, wherein determining the control plan comprises:
selecting a value for a change in right ascension of an ascending node of the first satellite or the second satellite; and
determining a value for a change in argument of latitude of the first satellite or the second satellite based on the change in right ascension,
wherein the control plan is determined based on solving a convex optimization problem based on the value for the change in argument of latitude and/or the value for the change in right ascension.

15. The method of claim 8, wherein the at least one computing device comprises at least one of the following: a computing device arranged remote from the plurality of satellites and in communication with at least one satellite of the plurality of satellites, a computing device arranged remote from the plurality of satellites and in communication with each satellite of the plurality of satellites, a computing device arranged on-board at least one satellite of the plurality of satellites, or any combination thereof.

16. A computer program product for controlling a plurality of satellites in orbit, comprising at least one non-transitory computer-readable medium that, when executed by at least one processor, causes the at least one processor to:
determine a control plan based on a target separation in along-track and cross-track directions for a plurality of satellites comprising at least a first satellite and a second satellite, the control plan comprising at least one drag modulation parameter for each satellite;
control the first satellite to lower an orbital altitude of the first satellite based on the at least one drag modulation parameter, such that a mean motion and nodal precession rate of the first satellite increases; and
based on the control plan and after lowering the orbital altitude of the first satellite, control the second satellite to lower an orbital altitude of the second satellite based on the at least one drag modulation parameter to achieve the target separation.

17. The computer program product of claim 16, wherein determining the control plan comprises optimizing a trajectory of drag modulation parameters for each satellite based on a target satellite formation.

18. The computer program product of claim 17, wherein optimizing the trajectory for drag modulation parameters comprises generating a differential-drag sequence for each of the first satellite and the second satellite.

19. The computer program product of claim 16, wherein controlling the second satellite results in cross-track separation and along-track separation between each of the plurality of satellites.

20. The computer program product of claim 16, wherein controlling the first satellite comprises altering an angle, orientation, attitude, and/or surface area of the first satellite to alter its drag.
